(19) United States
(12) Patent Application Publication
(10) Pub. No.: US 2014/0035846 A1
(43) Pub. Date: Feb. 6, 2014

(54) MOBILE TERMINAL AND CONTROLLING METHOD THEREOF

(71) Applicants: Yeonhwa LEE, Seoul (KR); Seho Kim, Seoul (KR)

(72) Inventors: Yeonhwa LEE, Seoul (KR); Seho Kim, Seoul (KR)

(21) Appl. No.: 13/931,217

(22) Filed: Jun. 28, 2013

(30) Foreign Application Priority Data
Aug. 1, 2012 (KR) 10-2012-0084305

(51) Int. Cl. G06F 3/0488

(52) U.S. Cl. CPC G06F 3/0488
USPC 345/173

(57) ABSTRACT

A mobile terminal and controlling method thereof are disclosed, which flexibly utilizes a display screen space of a mobile terminal in consideration of user's convenience and necessity. The present invention includes a touchscreen configured to display a main screen including at least one object, a memory configured to store an action corresponding to the at least one object, and a controller, if at least one of the at least one object is selected by a 1^{st} touch input to the touchscreen and an action display region is designated within the main screen by a 2^{nd} touch input, controlling an active action screen for the selected object to be displayed within the action display region.

### CROSS-REFERENCE TO RELATED APPLICATION(S)

This application claims priority under 35 U.S.C. §119 to Korean Application No. 10-2012-0084305, filed on Aug. 1, 2012, whose entire disclosure is hereby incorporated by reference.

### BACKGROUND

1. Field

The present invention relates to a mobile terminal, and more particularly, to a mobile terminal and controlling method thereof. Although the present invention is suitable for a wide scope of applications, it is particularly suitable for flexibly utilizing a display screen space of a mobile terminal in consideration of user's convenience and necessity.

2. Background

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to their degree (e.g., ease) of mobility. Further, the mobile terminals can be further classified into handheld terminals and vehicle mount terminals according to the manner of portability.

There are ongoing efforts to support and increase the functionality of mobile terminals. Such efforts include software and hardware improvements, as well as changes and improvements in the structural components which form the mobile terminal.

Regarding the above-configured mobile terminal, a spacious display screen in an appropriate range provides a user with convenience and facilitation. To this end, manufacturers tend to extend a display screen space by increasing a size of an LCD panel for displaying an active screen of an operation performed in a mobile terminal.

However, most of mobile terminals have the following problems. First of all, since an active screen of a single operation is displayed at a time irrespective of a size of a display screen space, the display screen space in a considerable size is not efficiently utilized. Secondly, since the active screen of the single operation is displayed only at a time, when the mobile terminal activates a new operation in response to a user's request, it is necessary to switch a screen in order to display an active screen of the corresponding operation. To this end, a battery power is additionally consumed. And, it is inconvenient for the user to switch the screen manually to watch a previous screen.

### SUMMARY OF THE INVENTION

Accordingly, embodiments of the present invention are directed to a mobile terminal and controlling method thereof that substantially obviate one or more problems due to limitations and disadvantages of the related art.

An object of the present invention is to provide a mobile terminal and controlling method thereof, by which an active screen of a new operation can be displayed without switching a displayed screen on activating the new operation in a manner of enabling a user to configure a display region within a display screen freely and flexibly.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a mobile terminal according to the present invention may include a touchscreen configured to display a main screen including at least one object, a memory configured to store an action corresponding to the at least one object, and a controller, if at least one of the at least one object is selected by a 1^{st} touch input to the touchscreen and an action display region is designated within the main screen by a 2^{nd} touch input, controlling an active action screen for the selected object to be displayed within the action display region.

In another aspect of the present invention, a method of controlling a mobile terminal according to the present invention may include the steps of controlling a touchscreen to display a main screen including at least one object, detecting a 1^{st} touch input of selecting at least one of the at least one object from the touchscreen, detecting a 2^{nd} touch input of designating an action display region within the main screen, selecting and activating an action for the selected object, and controlling the touchscreen to display an active screen of the action within the action display region.

In a further aspect of the present invention, an electronic recording medium according to the present invention may include a program recorded therein, the program including a 1^{st} command for controlling a touchscreen to display a main screen including at least one object, a 2^{nd} command for detecting a 1^{st} touch input of selecting at least one of the at least one object from the touchscreen, a 3^{rd} command for detecting a 2^{nd} touch input of designating an action display region within the main screen, a 4^{th} command for selecting and activating an action for the selected object, and a 5^{th} command for controlling the touchscreen to display an active screen of the action within the action display region.

Effects obtainable from the present invention may be non-limited by the above mentioned effect. And, other unmentioned effects can be clearly understood from the following description by those having ordinary skill in the technical field to which the present invention pertains.

It is to be understood that both the foregoing general description and the following detailed description of the present invention are exemplary and explanatory and are intended to provide further explanation of the invention as claimed.

### BRIEF DESCRIPTION OF THE DRAWINGS

The embodiments will be described in detail with reference to the following drawings in which like reference numerals refer to like elements wherein:

FIG. 1 is a block diagram of a mobile terminal according to one embodiment of the present invention;

FIG. 2 is a front perspective diagram of a mobile terminal according to one embodiment of the present invention;

FIG. 3 is a rear perspective diagram of a mobile terminal according to one embodiment of the present invention;

FIG. 4 is a flowchart for a method of controlling a mobile terminal according to one embodiment of the present invention;

FIG. 5A and FIG. 5B are diagrams for one example of a display unit of a mobile terminal having an active action screen displayed by a 1^{st} touch input and a 2^{nd} touch input;

FIG. 6A and FIG. 6B are diagrams for one example of an operation of a mobile terminal in case that a sequence of a 1^{st} touch input and a 2^{nd} touch input is determined;

FIG. 7 is a diagram for one example of a display unit of a mobile terminal having an active action screen displayed by an addition 3^{rd} touch input;

FIGS. 8A to 8D are diagrams for an example of an embodiment for an action executable in accordance with a type of a selected object;

FIG. 9 is a diagram for one example of an embodiment for an action executable in accordance with an application including a selected object;

FIG. 10A and FIG. 10B are diagrams for one example of an embodiment for selecting an action via a 4^{th} touch input when a plurality of actions correspond to a selected object;

FIG. 11A and FIG. 11B are diagrams for one example of an embodiment for shifting an active action display region via a 5^{th} touch input within a touchscreen;

FIG. 12 is a diagram for one example of an embodiment for ending an active action display region via a 6^{th} touch input; and

FIGS. 13A to 13C are diagrams for examples of an embodiment for an action executable in case that a plurality of objects are selected.

### DETAILED DESCRIPTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

Features of embodiments of the present invention are applicable to various types of terminals. Examples of such terminals include mobile terminals, such as mobile phones, user equipment, smart phones, mobile computers, digital broadcast terminals, personal digital assistants, portable multimedia players (PMP) and navigators. However, by way of non-limiting example only, further description will be with regard to a mobile terminal 100, and it should be noted that such teachings may apply equally to other types of terminals such as digital TV, desktop computers and so on.

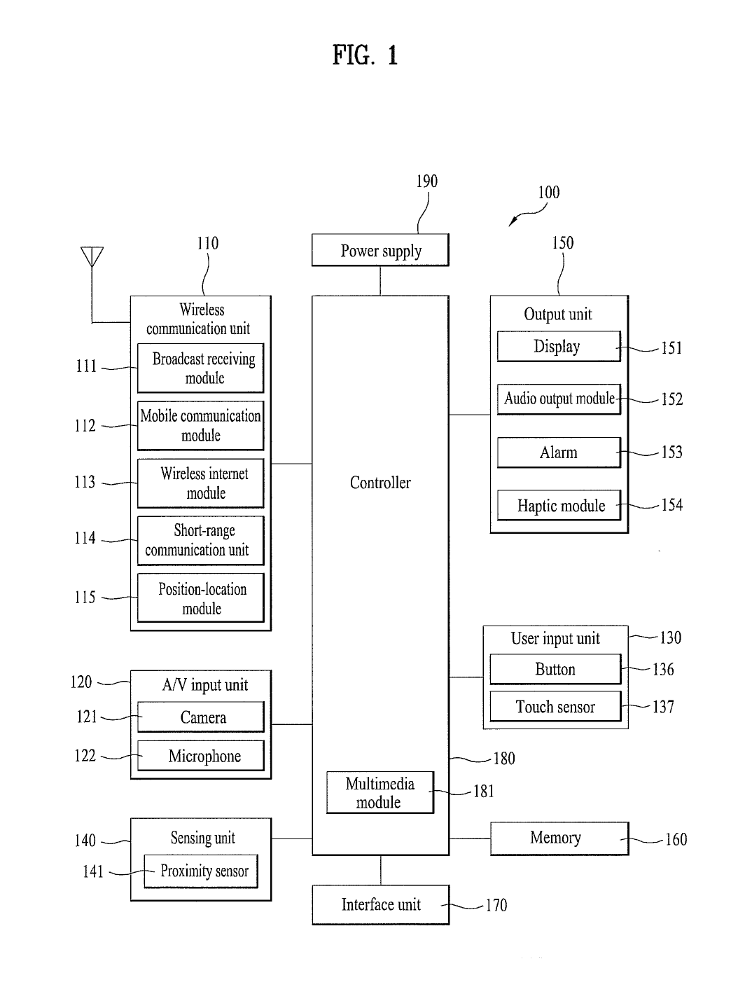

FIG. 1 is a block diagram of a mobile terminal 100 in accordance with an embodiment of the present invention. FIG. 1 shows the mobile terminal 100 according to one embodiment of the present invention includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. More or fewer components may be implemented according to various embodiments.

The wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel. The broadcast channel may include a satellite channel and a terrestrial channel. At least two broadcast receiving modules 111 can be provided in the mobile terminal 100 to facilitate simultaneous reception of at least two broadcast channels or broadcast channel switching.

The broadcast managing server is generally a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and/or a data broadcast signal, among other signals. If desired, the broadcast signal may further include a broadcast signal combined with a TV or radio broadcast signal.

The broadcast associated information includes information associated with a broadcast channel, a broadcast program, or a broadcast service provider. Furthermore, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and an electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), Convergence of Broadcasting and Mobile Service (DVB-CBMS), Open Mobile Alliance-BroadCAST (OMA-BCAST), China Multimedia Mobile Broadcasting (CMMB), Mobile Broadcasting Business Management System (MBBMS), the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as the memory 160.

The mobile communication module 112 transmits/receives wireless signals to/from one or more network entities (e.g., base station, external terminal, server, etc.) via a mobile network such as GSM (Global System for Mobile communications), CDMA (Code Division Multiple Access), WCDMA (Wideband CDMA) and so on. Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 facilitates relatively short-range communications. Suitable technologies for implementing this module include NFC (Near Field Communication), radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

According to the current technology, the GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a button 136 provided to front/rear/lateral side of the mobile terminal 100 and a touch sensor (constant pressure/electrostatic) 137 and may further include a key pad, a dome switch, a jog wheel, a jog switch and the like [not shown in the drawing].

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100. By nonlimiting example, such sensing unit 140 include, gyro sensor, accelerate sensor, geomagnetic sensor.

As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, and a haptic module 154 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and a sensor for detecting a touch action (hereinafter called ‘touch sensor’) configures a mutual layer structure (hereinafter called ‘touchscreen’), it is able to use the display 151 as an input device as well as an output device. In this case, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

Referring to FIG. 1, a proximity sensor 141 can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

For clarity and convenience of explanation, an action for enabling the pointer approaching the touchscreen to be recognized as placed on the touchscreen may be named ‘proximity touch’ and an action of enabling the pointer to actually come into contact with the touchscreen may be named ‘contact touch’. And, a position, at which the proximity touch is made to the touchscreen using the pointer, may mean a position of the pointer vertically corresponding to the touchscreen when the pointer makes the proximity touch.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include a Near Field Communication (NFC) Chip, User Identify Module (UIM), Subscriber Identity Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls The overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern (or image) recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

A battery may include a built-in rechargeable battery and may be detachably attached to the terminal body for a charging and the like. A connecting port may be configured as one example of the interface 170 via which an external charger for supplying a power of a battery charging is electrically connected.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

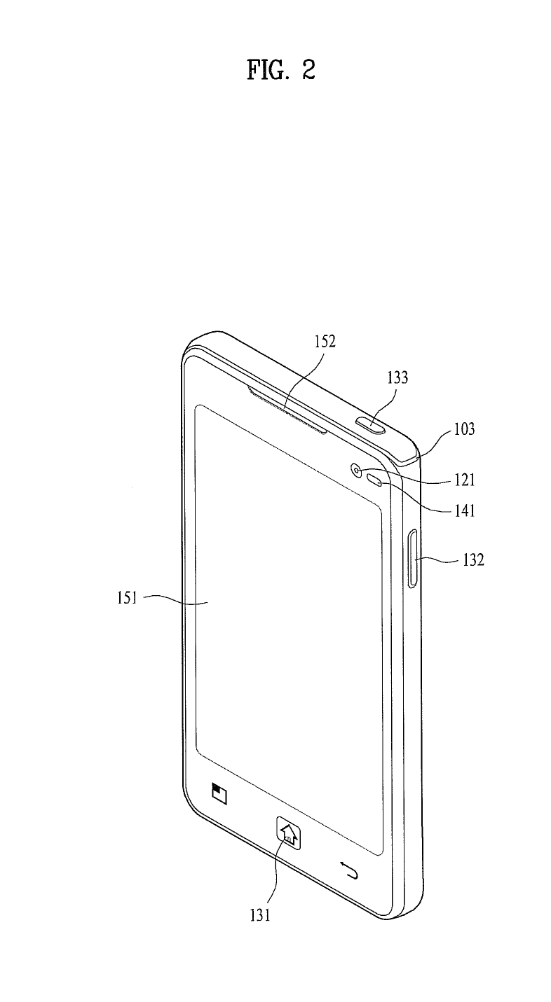

FIG. 2 is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 2, the mobile terminal 100 includes a case (casing, housing, cover, etc.) configuring an exterior thereof. In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

Occasionally, electronic components can be mounted on a surface of the rear case 102. The electronic part mounted on the surface of the rear case 102 may include such a detachable part as a battery, a USIM card, a memory card and the like. In doing so, the rear case 102 may further include a backside cover 103 configured to cover the surface of the rear case 102. In particular, the backside cover 103 has a detachable configuration for user's convenience. If the backside cover 103 is detached from the rear case 102, the surface of the rear case 102 is exposed.

Referring to FIG. 2, if the backside cover 103 is attached to the rear case 102, a lateral side of the rear case 102 may be exposed in part. If a size of the backside cover 103 is decreased, a rear side of the rear case 102 may be exposed in part. If the backside cover 103 covers the whole rear side of the rear case 102, it may include an opening 103′ configured to expose a camera 121′ or an audio output unit 152′ externally.

The cases 101 and 102 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the terminal body, and more particularly, to the front case 101.

The display 151 occupies most of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display 151 or the like can be inputted to the second manipulating unit 132.

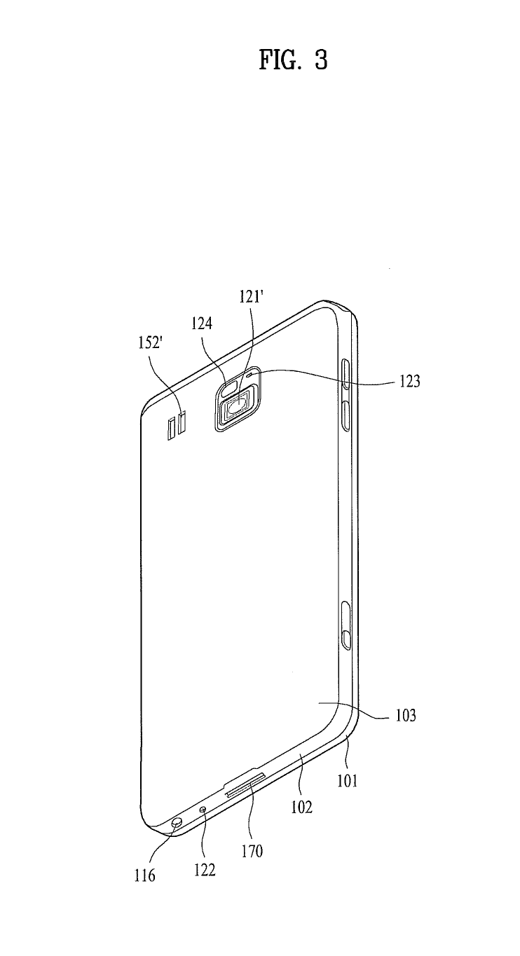

FIG. 3 is a perspective diagram of a backside of the terminal shown in FIG. 2.

Referring to FIG. 3, a camera 121′ can be additionally provided to a backside of the terminal body, and more particularly, to the rear case 102. The camera 121 has a photographing direction that is substantially opposite to that of the former camera 121 shown in FIG. 21A and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2 and may be used for implementation of a speakerphone mode in talking over the terminal.

A broadcast signal receiving antenna 116 can be additionally provided to the lateral side of the terminal body as well as an antenna for communication or the like. The antenna 124 constructing a portion of the broadcast receiving module 111 shown in FIG. 1 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad 135 for detecting a touch can be additionally provided to the rear case 102. The touchpad 135 can be configured in a light transmittive type like the display 151. In this case, if the display 151 is configured to output visual information from both of its faces, the visual information is viewable via the touchpad 135 as well. The information outputted from both of the faces can be entirely controlled by the touchpad 135. Alternatively, a display is further provided to the touchpad 135 so that a touchscreen can be provided to the rear case 102 as well.

The touchpad 135 is activated by interconnecting with the display 151 of the front case 101. The touchpad 135 can be provided in rear of the display 151 in parallel. The touchpad 135 can have a size equal to or smaller than that of the display 151.

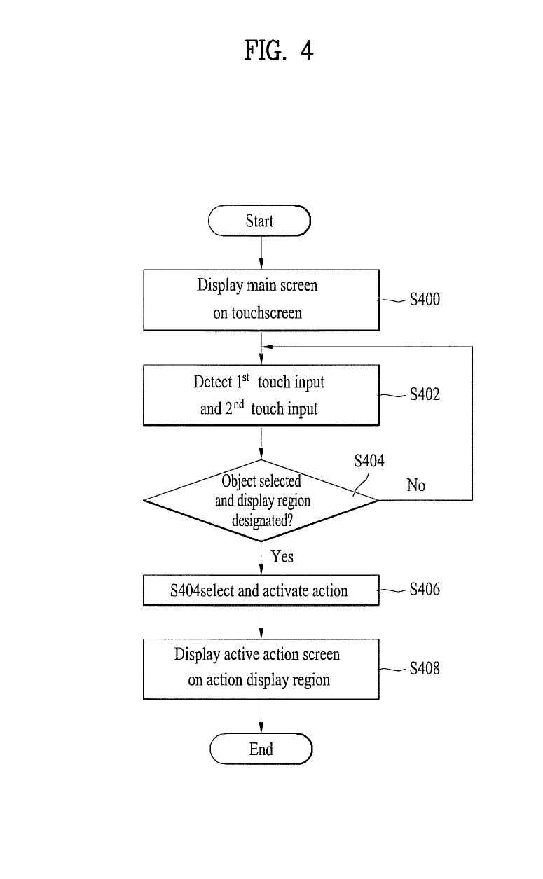

In the following description, a controlling method implemented in the above-configured mobile terminal according to one embodiment of the present invention is explained with reference to FIGS. 4 to 6.

For clarity of the following description, assume that a mobile terminal mentioned in the following description includes at least one portion of the former components shown in FIG. 1. In particular, a mobile terminal according to the present embodiment necessarily includes the display 151, the memory 160 and the controller 180 among the former components shown in FIG. 1. If the display 151 includes a touchscreen, implementation of the mobile terminal according to the present invention may be further facilitated. Therefore, the following description is made on the assumption that the display 151 includes a touchscreen.

FIG. 4 is a flowchart for a method of controlling a mobile terminal according to one embodiment of the present invention.

Referring to FIG. 4, a main screen including at least one object is displayed on the touchscreen [S400]. In this case, the main screen may include a user interface screen of an OS (operating system) of the mobile terminal or an active screen of a specific application implemented via software codes.

The user interface screen may include a home screen. In this case, the home screen may indicate a screen displayed in the first place when the touchscreen 151 of the mobile terminal is activated or a lock screen is unlocked after the activation of the touchscreen 151. On the home screen, application icons, application widgets and the like may be displayed on the home screen. And, at least two home screens may be provided.

While the main screen is displayed on the touchscreen 151, the controller 180 detects whether a touch input is performed on the touchscreen 151 [S404]. In this case, the touch input may be performed on the touchscreen 151 via a user finger, a stylus pen or the like. Regarding various touch inputs performed on the touchscreen 151, a 1^{st} touch input is provided to select an object included in the main screen and a 2^{nd} touch input is provided to designate an action display region within the main screen. In this case, the action display region may include the region configured within the main screen to display an active action screen for the selected object.

If the touch input is detected from the touchscreen 151, the controller 180 determines whether the touch input includes the input for selecting an object and designating an action display region [S404]. In particular, the controller 180 determines whether the 1^{st} touch input and the 2^{nd} touch input are detected. In this case, the 1^{st} touch input and the 2^{nd} touch input may be defined via a specific gesture or a relation to another touch input, by which the present invention may be non-limited. And, details of this embodiment shall be described later.

If the controller 180 determines that both of the 1^{st} touch input and the 2^{nd} touch input are detected, the controller 180 performs an action for the selected object [S406] and then displays an active screen of the action on a designated action display region [S408]. In this case, the action may indicate all operations that can be performed by the mobile terminal using hardware and/or software. And, a result of the corresponding operation may be outputted as an active action screen by being delivered to the display 151. The action corresponding to the object included in the main screen is saved in the memory 160 of the mobile terminal. The controller 180 searches the memory 160 for the action for the selected object and then performs the found action. Details and embodiments of the action shall be described later.

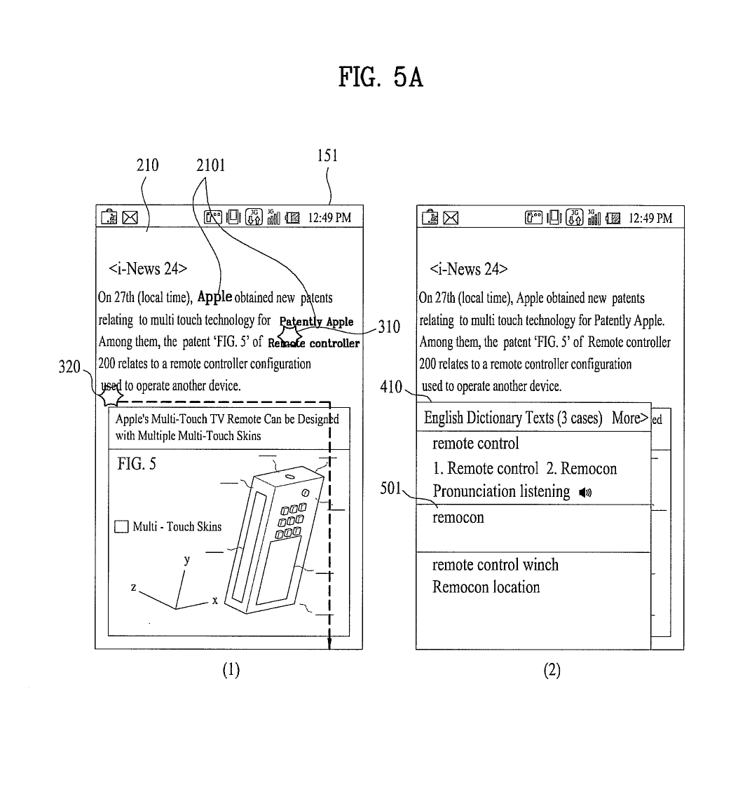

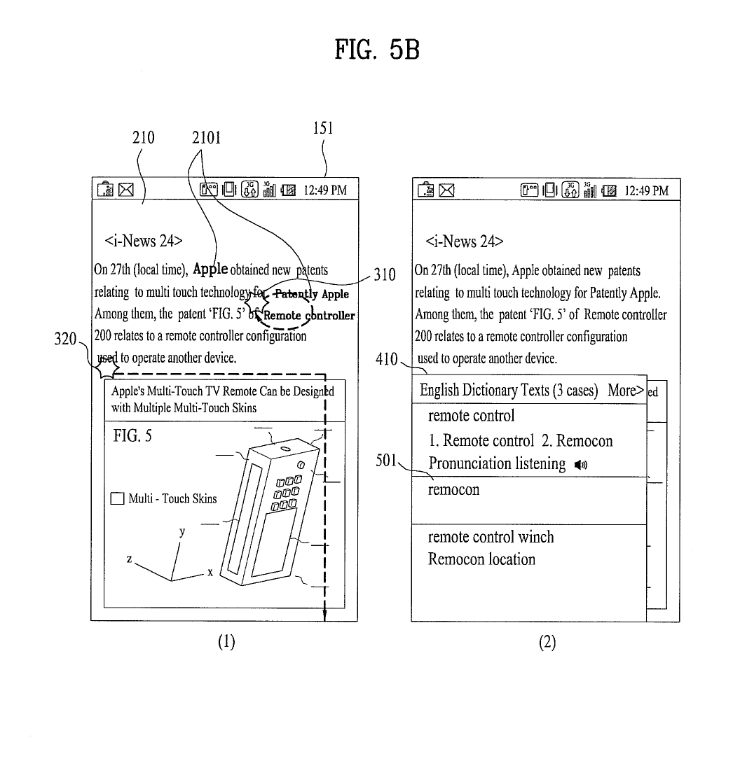

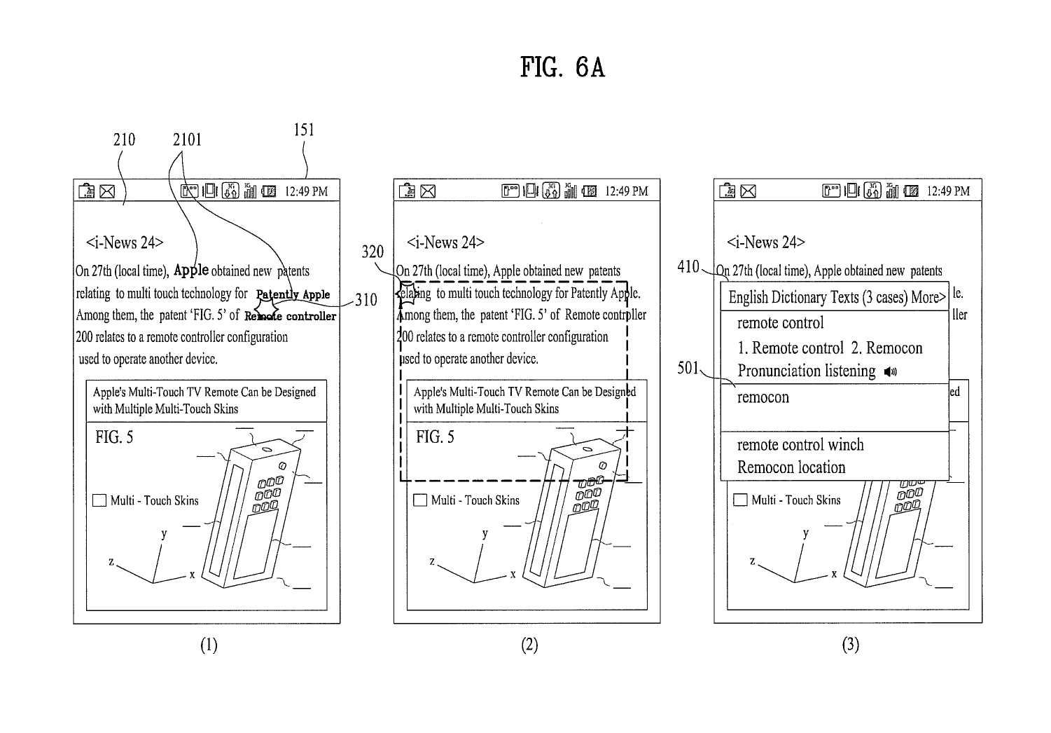

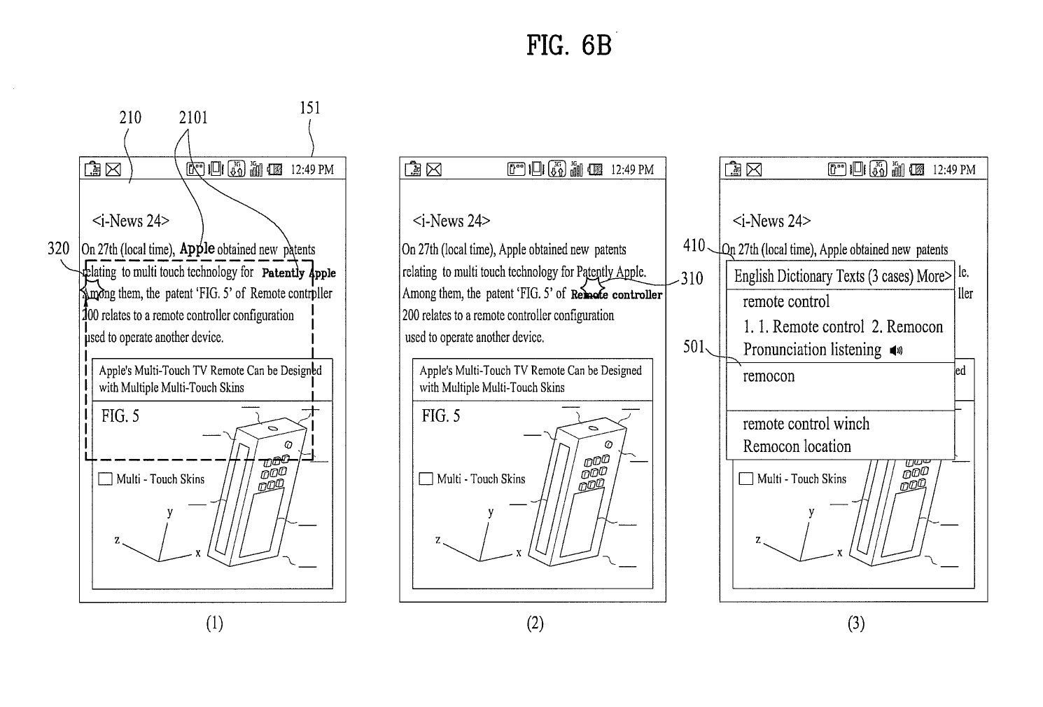

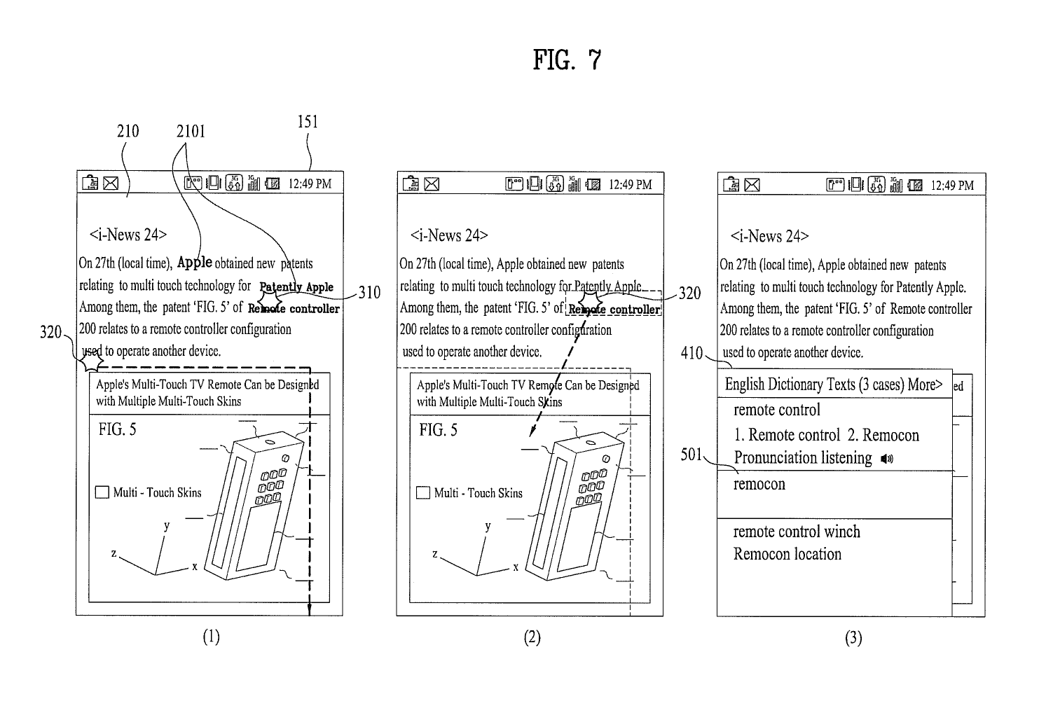

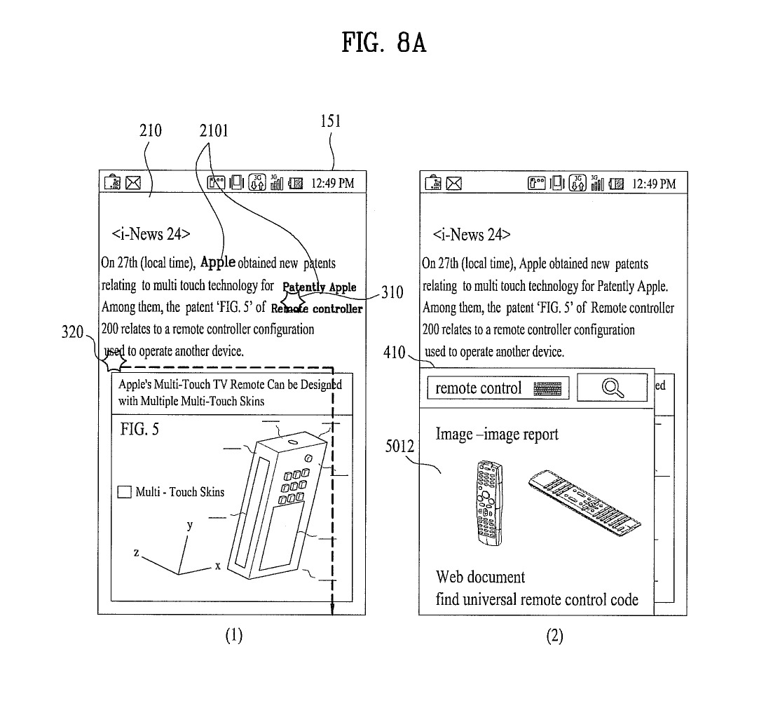

FIG. 5A and FIG. 5B are diagrams for one example of a display unit of a mobile terminal having an active action screen displayed by a 1^{st} touch input and a 2^{nd} touch input.

Referring to FIG. 5A, while a main screen 210, which is an active screen of an internet browser application for outputting a new webpage, is displayed, an object of a text ‘remote controller’ 2101 is selected by a 1^{st} touch input 310 and an action display region 410 is designated to a bottom part of the touchscreen 151 by a 2^{nd} touch input 320. In response to the 1^{st} touch input 310 and the 2^{nd} touch input 320, the controller 180 performs an action of a dictionary search for the word ‘remote controller’ and then displays a result of the action on the action display unit 410.

According to the present embodiment, an active action screen can be displayed on an action display region, which occupies a prescribed portion of a main screen without switching the main screen previously displayed on the touchscreen. As a result, the main screen is maintained and a new active action screen can be displayed on the touchscreen. Moreover, since a location and size of the actin display region are determined by a user's touch input, the user is able to watch an active screen of a new action in a desired size at a desired location. And, it is able to maximize utilization of a display screen space of the touchscreen in accordance with necessity and desire.

In spite that various touch inputs are detected, if any one of the detected touch inputs fails to match the 1^{st} touch input or the 2^{nd} touch input, at least one of the object selection and the action display region designation is not performed. In this case, the controller 180 does not perform any action but controls the touchscreen to maintain the main screen previously displayed.

In the following description, a mobile terminal and controlling method thereof according to one embodiment of the present invention are explained in detail with reference to FIGS. 5A to 13C.

First of all, FIGS. 5A to 7 show various embodiments for performing an object selection and a designation of the action display region 410 by the 1^{st} touch input 310 and the 2^{nd} touch input 320.

According to one embodiment, referring to FIG. 5A and FIG. 5B, specific touch gestures may be designated to a 1^{st} touch input 310 and a 2^{nd} touch input 320, respectively. In particular, a 1^{st} gesture may be designated as the 1^{st} touch input 310 and a 2^{nd} gesture may be designated as the 2^{nd} touch input 320. In this case, the 1^{st} gesture and the 2^{nd} gesture may be separately designated in advance consecutively or non-consecutively.

The controller 180 may be able to detect the 1^{st} and 2^{nd} gestures, which are inputted consecutively, as the 1^{st} touch input 310 and the 2^{nd} touch input 320, respectively. Alternatively, such a different gesture as a gesture for scrolling a main screen 210 may be performed on a region between the 1^{st} gesture and the 2^{nd} gesture. In doing so, the different gesture performed on the region between the 1^{st} gesture and the 2^{nd} gesture does not affect an object select action and an action display region designation action. If both of the 1^{st} touch input 310 and the 2^{nd} touch input 320 are detected, the controller 180 performs an action for the selected object to display an active action screen 501.

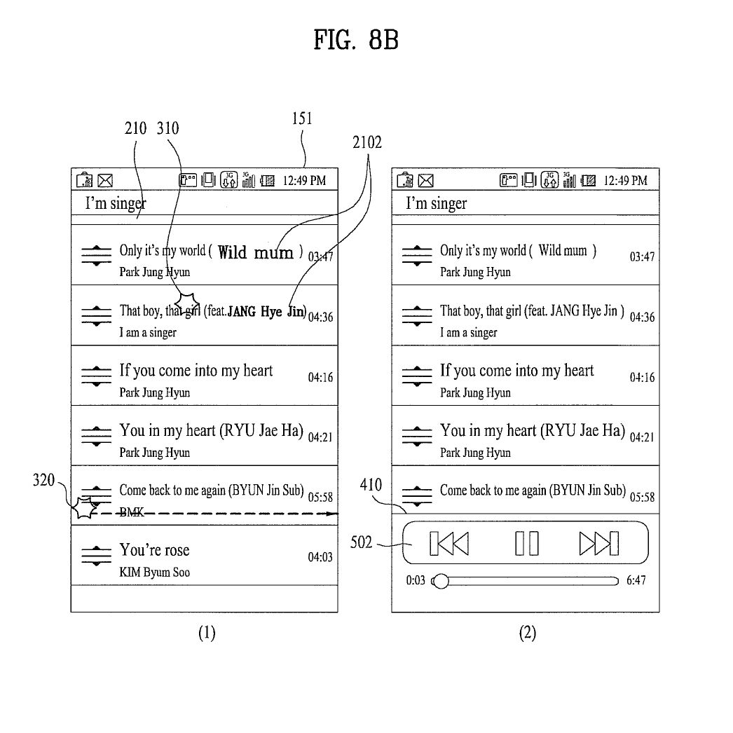

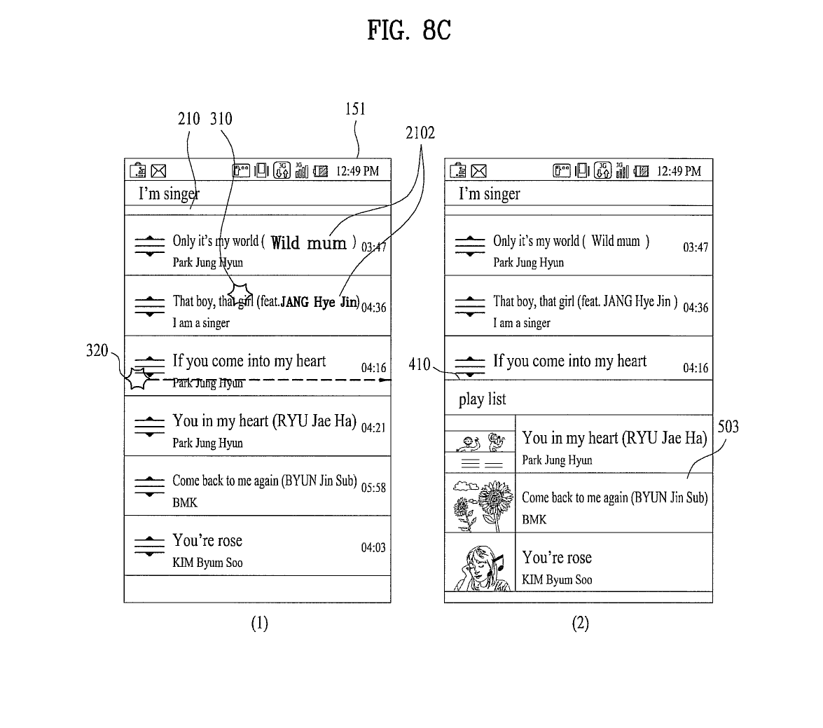

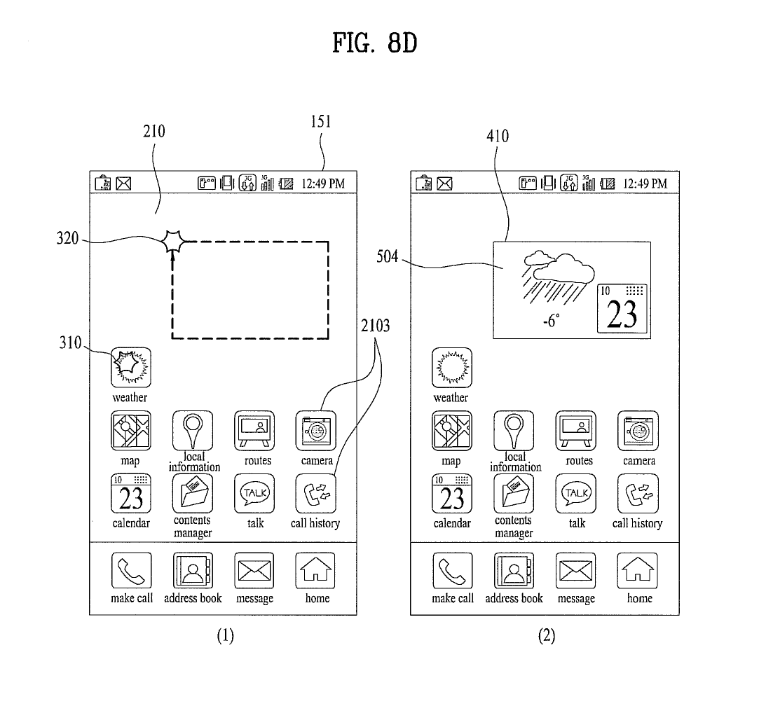

In particular, referring to FIG. 5A (1), a tap may be designated as the 1^{st} gesture and a touch drag for designating a predetermined region may be designated as the 2^{nd} gesture. In this case, the touch drag may include a touch drag action of drawing such a closed loop trace as a quadrangle, a circle and the like. Alternatively, the touch drag may include a touch drag action of drawing a trace for partitioning a display screen using edges of the touchscreen [FIG. 5A, FIG. 8A]. Moreover, the 2^{nd} gesture of the present embodiment may include an action of designating a predetermined region located at a left bottom of the touchscreen 151 by performing a touch drag of a shape ‘ [symbol] ’ on a region around a left bottom corner of the touchscreen 151 [FIG. 5A (1)]. As a result, this designating action can be recognized as the 2^{nd} touch input 320 by the controller 180.

If the 1^{st} and 2^{nd} gestures designated in the above manner are detected, the controller 180 recognizes the 1^{st} gesture and the 2^{nd} gesture as the 1^{st} touch input 310 and the 2^{nd} touch input 320, respectively and is then able to select an object situated at the location, on which the 1^{st} touch input 310 has been performed, and to designate the region, which is designated via the 2^{nd} touch input 320, as the action display region 410. After the object has been selected and the action display region 410 has been designated, referring to FIG. 5A (2), the controller 180 performs a dictionary search, which is an action corresponding to the selected object (e.g., ‘remote controller’ text 2101), and displays the active action screen 501 on the action display region 410.

Alternatively, referring to FIG. 5B (1), each of the 1^{st} gesture and the 2^{nd} touch gesture may include a touch drag for designating a prescribed region. In this case, one of the two touch drags, of which designated region is greater than that of the other, may be recognized as the 2^{nd} gesture irrespective of the input sequence.

Since a size of the region designated by the touch drag action of drawing a circular trace on an upper part is greater than that of the region designated by the touch drag action of drawing the shape ‘ [symbol] ’ on a lower part in FIG. 5B (1), the touch drag action performed on the lower part becomes the 2^{nd} gesture. Hence, as the touch drag action performed on the lower part is detected as the 2^{nd} touch input 320, a left lower part of the touchscreen 151 is designated as the action display region 410. As the touch drag action performed on the upper part is detected as the 1^{st} touch input 310, the object located at the center of the upper part is selected. Once both of the 1^{st} touch input 310 and the 2^{nd} touch input 320 are detected, referring to FIG. 5B (2), the controller 180 performs an action for the selected object in response to the detection and then displays the active action screen 501 on the action display region 410.

According to the present embodiment, if specific gestures different from each other are designated as the 1^{st} touch input 310 and the 2^{nd} touch input 320, respectively, irrespective of the input sequence of the 1^{st} touch input 310 and the 2^{nd} touch input 320, once both of the 1^{st} touch input 310 and the 2^{nd} touch input 320 are detected, it may be able to display the active action screen 501 corresponding to the selected object in response to the detection. The corresponding cases are shown in FIG. 6A and FIG. 6B, respectively.

FIG. 6A and FIG. 6B are diagrams for one example of an operation of a mobile terminal in case that a sequence of a 1^{st} touch input and a 2^{nd} touch input is determined.

Referring to FIG. 6A (1) and FIG. 6A (2), the 1^{st} touch input 310, for which a tap gesture is designated, is performed and the 2^{nd} touch input 320, for which a touch drag gesture is designated, can be then performed in continuation with the 1^{st} touch input 310. Thus, if the 1^{st} touch input 310 and the 2^{nd} touch input 320 are performed in order, referring to FIG. 6A (3), it may be able to display the active action screen 501 in response to the 2^{nd} touch input 320.

On the contrary, referring to FIG. 6B (1) and FIG. 6B (2), the 2^{nd} touch input 320, for which a touch drag gesture is designated, is performed and the 1^{st} touch input 310, for which a tap gesture is designated, can be then performed in continuation with the 2^{nd} touch input 320. Thus, if the 2^{nd} touch input 320 and the 1^{st} touch input 310 are performed in order, referring to FIG. 6B (3), it may be able to display the active action screen 501 in response to the 1^{st} touch input 310.

FIG. 7 is a diagram for one example of a display unit of a mobile terminal having an active action screen displayed by an addition 3^{rd} touch input.

According to another embodiment, referring to FIG. 7, a 1^{st} touch input 310 and a 2^{nd} touch input 320 may be identified in accordance with a 3^{rd} touch input 330 detected behind the 1^{st} touch input 310 and the 2^{nd} touch input 320. In this case, the 3^{rd} touch input 330 is provided to match the 1^{st} touch input 310 and the 2^{nd} touch input 320 to each other. And, no limitation is put on the format of the 3^{rd} touch input 330.

For instance, the 3^{rd} touch input 330 may be defined to connect one point of the touchscreen 151, on which the 1^{st} touch input 310 is performed, and another point, on which the 2^{nd} touch input 320 is performed, to each other. Alternatively, the 3^{rd} touch input 330 may be defined as a gesture performed as if moving one of the 1^{st} touch input performed point and the 2^{nd} touch input performed point to the other. In response to the above-described 3^{rd} touch input 330, the controller activates an action on a selected object and may display an active action screen 501.

After two of various touch inputs supposed to be performed on the touch screen have been performed, if the 3^{rd} touch input 330 for matching the two touch input performed points to each other is performed, the controller 180 recognizes one of the two touch inputs as the 1^{st} touch input 310 and also recognizes the other as the 2^{nd touch input 320. In doing so, the two touch inputs recognized as the} 1^{st} touch input 310 and the 2^{nd} touch input 320 may be performed consecutively or non-consecutively.

Which one of the two touch inputs is recognized as the 1^{st} touch input 310 (or the 2^{nd} touch input 320) may be determined based on start and end points of the 3^{rd} touch input 330.

For instance, one of the two touch inputs, which is performed on a potion closer to a start point of the 3^{rd} touch input 330, may be recognized as the 1^{st} touch input 310 and the other, which is performed on a portion closer to the end point of 3^{rd} touch input 330, may be recognized as the 2^{nd} touch input 320. Hence, an object located at the start point of 3^{rd} touch input 330 is selected, a region designated by the 2^{nd} touch input 320 at the end point of the 3^{rd} touch input 330 may become an action display region 410, and the controller 180 may be able to display an active action screen 501 for the selected object on the action display region 410.

In particular, referring to FIG. 7 (a), the 3^{rd} touch input 330 may include an input of touch-dragging the selected object and then touch-dropping the selected object onto the actin display region 410. According to the present embodiment, a touch input performed ahead of the start point of the 3^{rd} touch input 330, which is a drag & drop input, is recognized as the 1^{st} touch input 310 and a touch input performed ahead of the end point of the 3^{rd} touch input 330 is recognized as the 2^{nd} touch input. If the drag & drop input is detected, referring to FIG. 7 (2), the controller 180 displays the active action screen 501 for the object selected by the 1^{st} touch input 310 on the action display region 410 designated by the 2^{nd} touch input 320 in response to the drag & drop input.

In the above description, various embodiments of the 1^{st} touch input 310 and the 2^{nd} touch input 320, which can be inputted as a command for the controller 180 to activate or execute an action and to display the active action screen 501 on a partial region of the touchscreen 15, are explained. In the following description, various methods of designating an action to be activated for a specific object and a detailed embodiment of the action shall be explained. Actions for objects may be designated in a manner of being unified into one, in accordance with a type of the corresponding object, or in accordance with an application in which the corresponding object is included.

In case that an action is designated in accordance with a type of an object or an object included application, the controller 180 may determine a type of the object previously selected in the action selecting and activating step S406 or may check an application in which the selected object is included. Thereafter, the controller 180 may select an action corresponding to the type of the object or an action corresponding to the application.

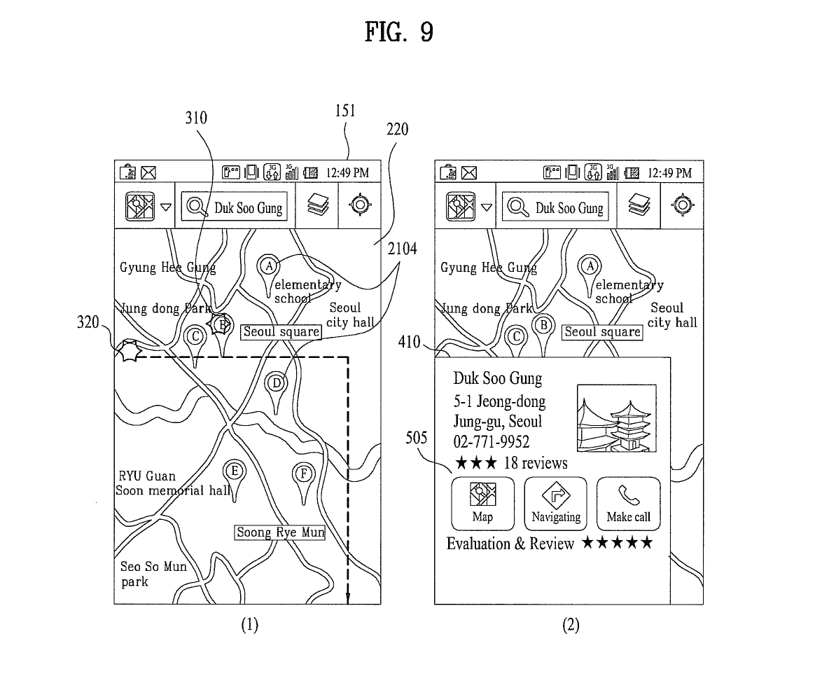

FIGS. 8A to 9 show various embodiments of an action that can be activated for an object selected by a 1^{st} touch input 310.

FIGS. 8A to 8D are diagrams for an example of an embodiment for an action executable in accordance with a type of a selected object. And, FIG. 9 is a diagram for one example of an embodiment for an action executable in accordance with an application including a selected object.

According to one embodiment, an action for a selected object may be designated in accordance with a type of the object. In this case, the type of the object may include at least one of a text, an application icon and a multimedia content. And, an action corresponding to a type of each object may be saved in the memory 160 of the mobile terminal. In response to a 1^{st} touch input 310 and a 2^{nd} touch input 320, the controller 180 determines a type of a selected object, selects an action to activate in accordance with the type of the object, and is then able to display an active action screen on an action display region 410.

In particular, in case that the type of the object is the text 2101, as mentioned in the foregoing descriptions of FIGS. 5A to 7, an action corresponding to the object type may include an operation of searching a dictionary saved in the memory 160 for the text 2101. In this case, if the object selected by the 1^{st} touch input 310 is determined as the text 2101, the controller 180 searches the dictionary for the selected text 2101 and then displays the active screen 501 of the action.

Referring to FIG. 8A, in case that a type of an object is a text 2101, a corresponding action may include an operation of activating a web browser and then searching a webpage for the text 2010. In this case, if it is determined that an object selected by a 1^{st} touch input 310 is the text 2101, the controller 180 activates the web browser, searches a search engine for the selected text 201, and the displays a corresponding result screen 5012.

For another example, referring to FIG. 8B, in case that a type of an object is a multimedia content 2102, an action corresponding to the object type may include an operation of playing the multimedia content 2102. In particular, referring to FIG. 8B (1), if one of musics saved in the memory 160 of the mobile terminal is selected via the 1^{st} touch input 310 and an action display region 410 is designated to a lower part of the touchscreen 151 via a 2^{nd} touch input 320, the controller 180 determines a type of the selected object in response to the 1^{st} touch input 310 and the 2^{nd} touch input 320. If the controller 180 determines that the selected object is the music, referring to FIG. 8B (2), the controller 180 activates an action of playing the selected music and is then able to display a music play bar, which is a corresponding active action screen 502, on the action display region 410.

Besides, in case that a selected object is a video multimedia content, an action corresponding to the selected object may include an operation of playing the selected object [not shown in the drawing]. If a prescribed video is selected from a video list via a 1^{st} touch input 310 and an action display region 410 is designated via a 2^{nd} touch input 320, the controller 180 plays the selected video and is then able to output a screen of the played video to the action display region 410.

For another example, in case that a type of an object is a multimedia content 2102, an action corresponding to the object type may include an operation of adding the selected multimedia content to a list saved in the memory 160 of the mobile terminal. Referring to FIG. 8C (1) and FIG. 8C (2), if a music corresponding to the multimedia content 2102 is selected via a 1^{st} touch input 310 and an action display region 410 is designated via a 2^{nd} touch input 320, the controller 180 searches a music play list saved in the memory 160, selects a music from the searched music play list, and then adds the selected music to the music play list. And, a play list 503, to which the selected music is added, can be outputted to the action display region 410.

Once the selected object is added to the play list 503 by the above-described operation, a modified play list can be newly saved in the memory 160. Alternatively, while the action display region 410 is outputted, if a prescribed object is selected from the play list 503, the selected multimedia content can be played.

Alternatively, in case that a selected object is a text 2101, an action corresponding to the selected object may include an operation of adding the selected text 2101 to a list saved in the memory 160 of the mobile terminal. For instance, if a user selects a series of numerals via a 1^{st} touch input 310 and designates an action display region 410 via a 2^{nd} touch input 320, the controller 180 searches the memory 160 for a contact list, reads the found contact list, adds the selected numerals to the contact list as a phone number, and is then able to display the phone number on the action display region 410.

For another example, referring to FIG. 8D, in case that a type of an object is an application icon 2103, an action corresponding to the object type may include an operation of activating a widget of an application corresponding to the selected icon 2103. Referring to FIG. 8D (1), if a user selects a weather icon from the application icons 2103 arranged on a background screen of the mobile terminal via a 1^{st} touch input 310 and designates a portion of a right upper part of the screen via a 2^{nd} touch input 320 as an action display region 410 via a 2^{nd} touch input 320, the controller 180 determines that the type of the selected object is the application icon 2103, activates a widget 504 of the application corresponding to the selected application icon 2103, and is then able to display the activated widget 504 on the action display region 410. Since the weather icon 2013 is selected, referring to FIG. 8D (2), the widget 504 of the weather indication application can be displayed on a user-designated region located at the right upper part of the screen.

Unlike the above-mentioned embodiments, actions for the objects may be designated in a manner of being unified into one. In this case, a same action may be activated irrespective of a type of a selected object and an action selecting operation of the controller 180 may be omitted from the action selecting and activating step S406 shown in FIG. 4.

According to another embodiment, an action for a selected object may be designated in accordance with an application that can be activated by the controller 180. No matter what a type of an application is, according to the present embodiment, only if a selected object is contained in an active screen of an application, an action designated to the corresponding application can be activated. In doing so, a main screen 210, to which a 1^{st} touch input 310 and a 2^{nd} touch input 320 are applied, can become the active screen of the application.

For example, referring to FIG. 9, in case that a main screen includes an active screen 220, an actin corresponding to the main screen may include an operation of searching for information on an object included in a corresponding application and reading the found information. FIG. 9 shows a case that a main screen includes an active screen 220 of a map application. Referring to FIG. 9 (1), if a user selects one of icons 2104 appearing on an active screen of a map application via a 1^{st} touch input 310 and designates an action display region 410 via a 2^{nd} touch input 320, the controller 180 is able to activate an action previously designated to the map application. If an operation of loading information on a selected object from an application is designated as an action, referring to FIG. 9 (2), an operation of loading information on a place or building indicated by the selected icon 2104 is activated and a corresponding information output screen 505 can be displayed on the action display region 410.

According to the present invention, as mentioned in the foregoing description, an action corresponding to an object included in the main screen is saved in the memory 160 of the mobile terminal 100. According to one embodiment, the action for the object can be designated by a user. In this case, the user is able to designate a different action in accordance with one of a type of the object, an application having the main screen 210 as an active screen and the like. For an application having the main screen 210 as an active screen, a different action may be designated in a manner of categorizing an object included in the active application screen by types. Through this, the user is able to designate a desired action for a specific object. As a result, it may be able to enhance usability of the mobile terminal 100.

In the above description, the various methods of designating an action for each object and the detailed examples of the actions are explained. In the following description, explained are a controlling method in case of at least two actions designated for a selected object, a method of controlling an action display region in a state that an active action screen for a selected object is displayed, and a controlling method in case of at least two selected objects.

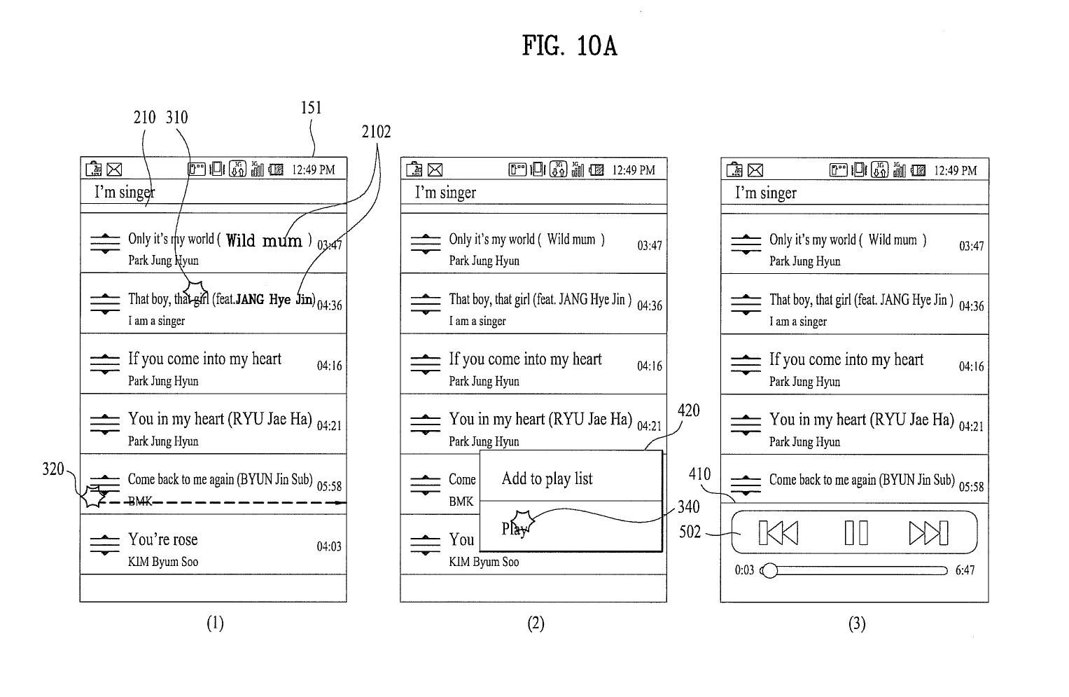

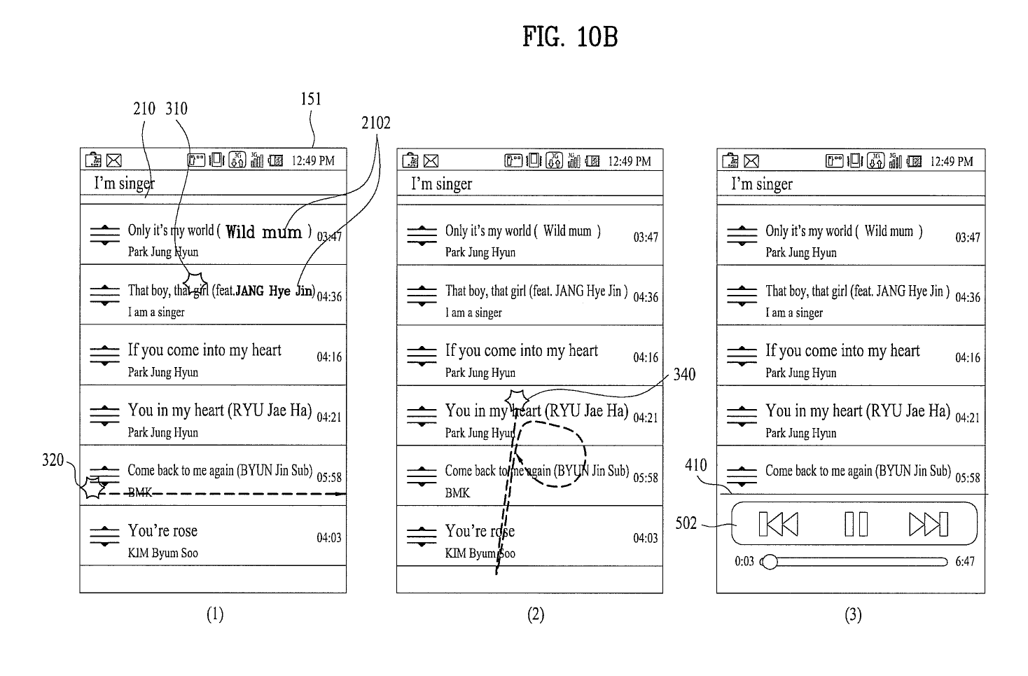

FIG. 10A and FIG. 10B show various embodiments for a method for a user to select an action in case that a plurality of actions corresponding to a selected object exist.

According to one embodiment, in case that a plurality of actions corresponding to a selected object exist, one of a plurality of the actions may be selected via a 4^{th} touch input 340 additionally inputted to the touchscreen 151. In this case, the 4^{th} touch input 340 may be performed after performing a following one of a 1^{st} touch input 310 and a 2^{nd} touch input 320. Alternatively, if there is a 3^{rd} touch input 330, the 4^{th} touch input 340 may be performed after performing the 3^{rd} touch input 330.

In particular, referring to FIG. 10A, an action for a selected object may be selected from a list 420 popping up via a 4^{th} touch input 340 after a 1^{st} touch input 310 and a 2^{nd} touch input 320. In doing so, actions corresponding to the selected object may be enumerated on the popup list 420. In case that the selected object is a multimedia content 2102, an action of activating the selected multimedia content 2102 and an action of adding the selected multimedia content 2102 to a play list may correspond to the selected object.

In this case, if both of the 1^{st} touch input 310 and the 2^{nd} touch input 320 are detected in FIG. 10A (1), referring to FIG. 10A (2), the controller 180 may be able to display a list 420 on which the actions are enumerated. If a prescribed action is selected from the list 420 via the 4^{th} touch input 340 of a tap input, referring to FIG. 10A (3), the controller 180 activates the selected action and is then able to display an active action screen 502 on a display region 410.

For another example, referring to FIG. 10B, an action for a selected object may be selected by a 4^{th} touch input 340, which is a touch drag input of drawing a specific character. In this case, an initial or numeral may be designated to each of a plurality of actions corresponding to the selected object. If the selected object is the multimedia content 2102 shown in FIG. 10A and a play operation and an operation of addition to a play list correspond to the selected multimedia content 2102, an initial ‘P’ is designated to the play operation and an initial ‘L’ may be designated to the play list addition operation.

In this case, a user performs both a 1^{st} touch input 310 and a 2^{nd} touch input 320 [FIG. 10B (1)] and is then able to perform a touch drag input that follows a trace of the initial ‘P’ [FIG. 10B (2)]. The controller 180 recognizes the touch drag input as an input of selecting a play operation action, plays the corresponding multimedia, and is then able to display an active screen 502 of the played multimedia on an action display region 410.

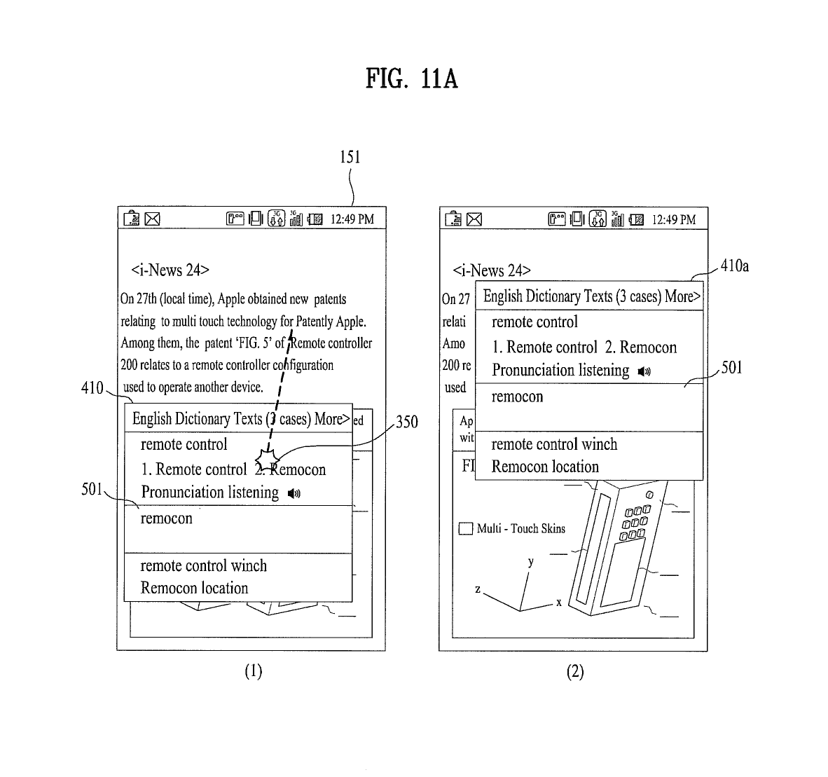

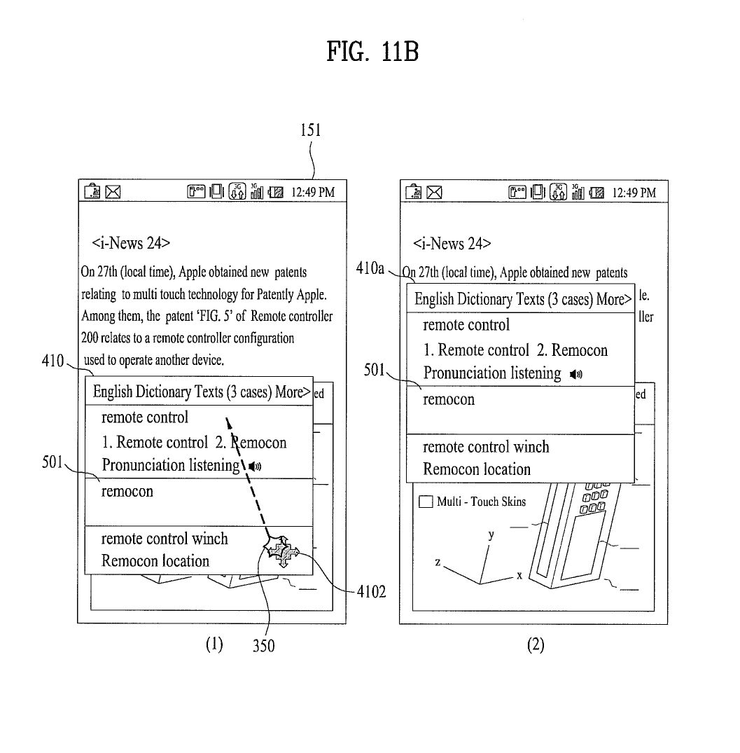

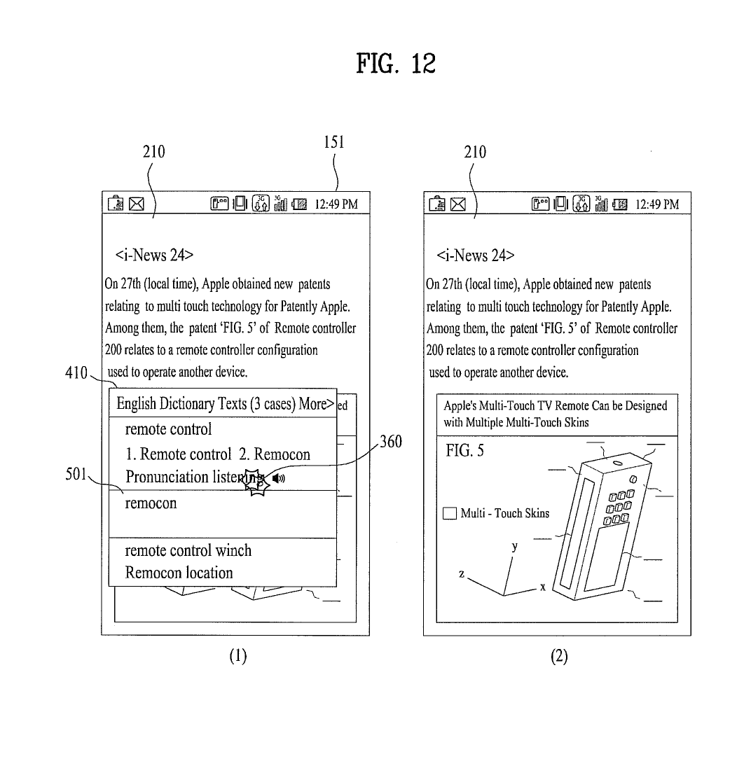

FIGS. 11A to 12 show various embodiments of a method of controlling an action display region 410 while an active action screen 501 is displayed on the action display region 410.

According to one embodiment, if a touch drag 350 is performed on an action display region 410, a location of an action display region 410 may be shifted. If a start point of the touch drag input 350 is situated within the action display region 410, the action display region 410 may be shifted to an end location of the touch drag input 350. According to the present invention, the action display region 410 is visually activated only if an active action screen 501 is displayed. Hence, the touch drag input 350 for the shift of the action display region 410 is performed on the active action screen 501.

For example, referring to FIG. 11A (1), the touch drag input 350 performed on the action display region 410 is able to shift the action display region 410 only if its end point is situated outside the action display region 410. In this case, the touch drag input 350 of which start and end points are situated within the action display region 410, may be recognized as an input for scrolling the active action screen 501 within the action display region 410. And, it is able to discriminate the input for scroll and the input for shift from each other based on a location of the end point. If the touch input 350 shown in FIG. 11A (1) is performed, referring to FIG. 11A (2), a location of the action display region 410 may be changed within the main screen 210, which is indicated by a reference number ‘410a’ in the drawing. In this case, the shift of the action display region 410 occurs after the touch drag input 350 has been completed.

For another example, referring to FIG. 11B (1), the touch drag input 350 performed on the action display region 410 is able to shift the action display region 410 if its start point overlaps with a previously designated location within the action display region 410. In this case, the previously designated location may be represented as a specific icon 4102. If a user touches the icon 2103 and then performs a drag 350, referring to FIG. 11B (2), a location of the action display region 410 is changed, which is indicated by a reference number ‘410a’ in the drawing. Yet, despite that the touch frag input 350 is performed, if the start point of the touch drag input 350 is not the icon 2103, the active action screen 501 may be scrolled without shifting the action display region 410.

According to another embodiment, regarding the activated action display region 410, the designation of the action display region 410 may be cancelled by a 5^{th} touch input 360 additionally performed within the action display region 410. The 5^{th} touch input 360 may include a specific gesture. If the designation of the action display region 410 is cancelled, the active action screen 501 may stop being displayed or a display region of the active action screen 501 may extend to a full screen of the touchscreen 151. Both of the gesture for commanding the end of the active action screen 501 and the gesture for commanding the enlargement of the active action screen 501 may be simultaneously designated to the 5^{th} touch input 360.

For example, while the active action screen 501 is displayed on the action display region 410, if a user performs a tap input (e.g., double tap) 360, which is repeated within prescribed time, on the action display region 410 [FIG. 12 (1)], the designation of the action display region 410 may be cancelled and the display of the active action screen 501 may be ended [FIG. 12 (2)]. As the display of the active action screen 501 is ended, the main screen 210 may be displayed on the touchscreen 151 only.

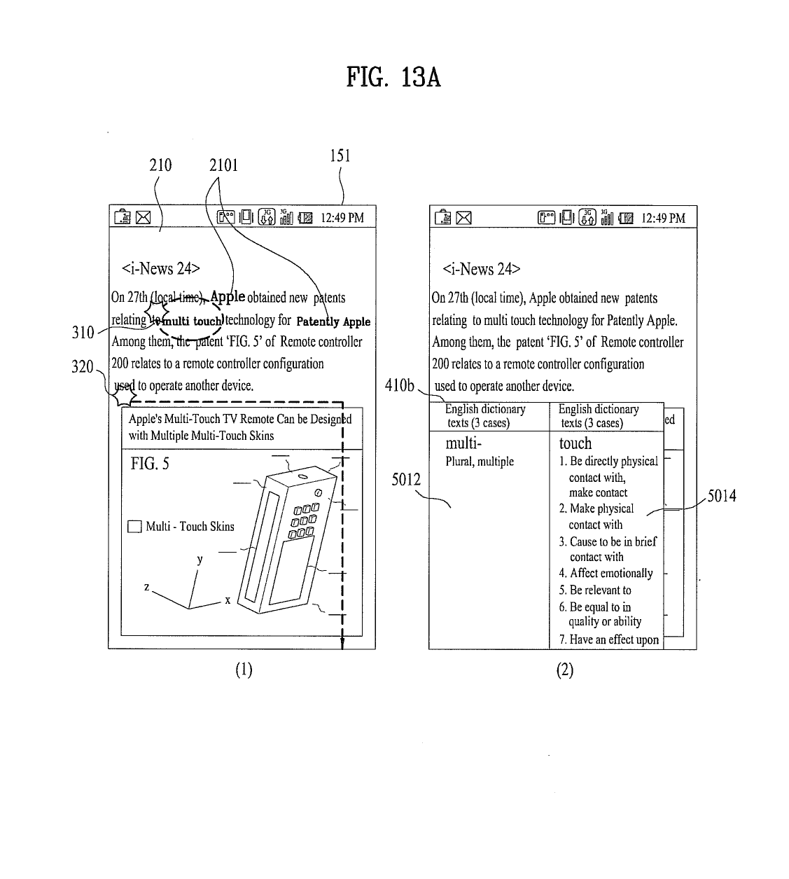

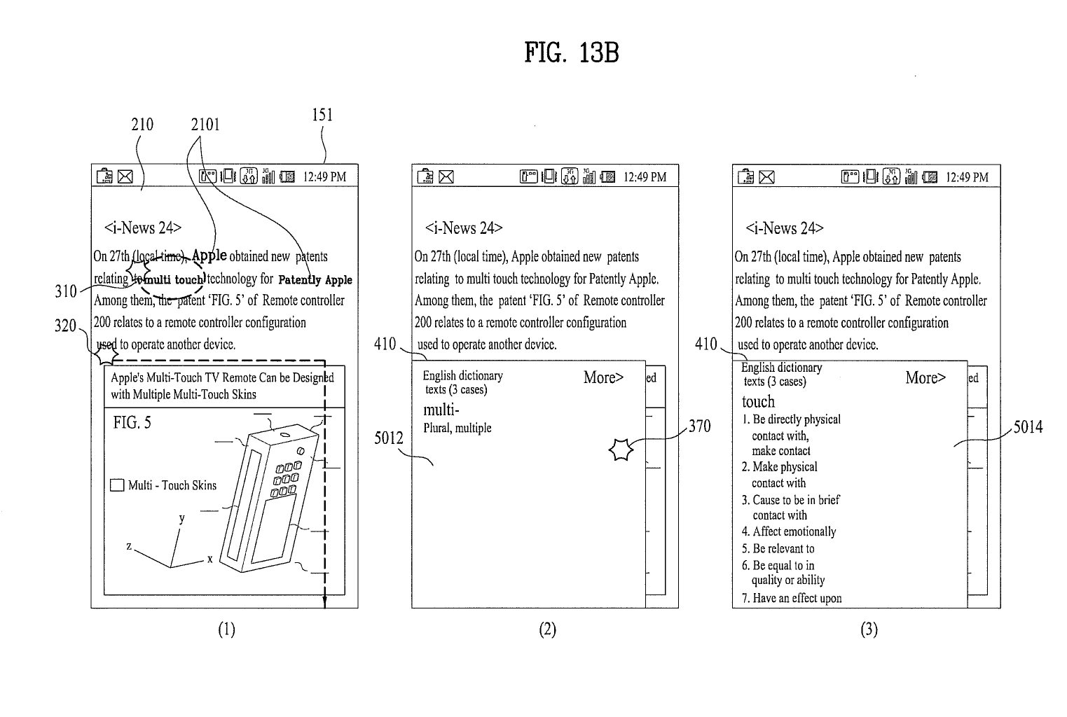

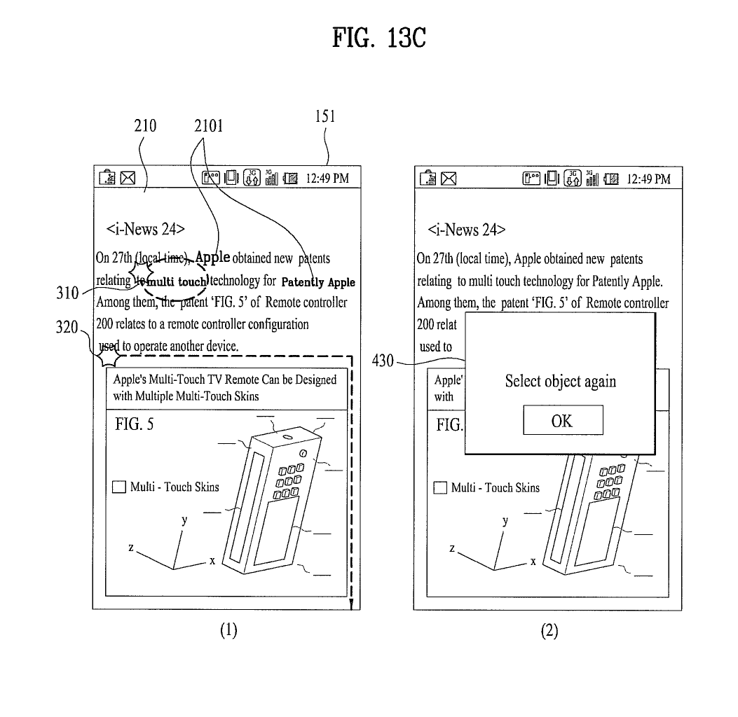

In addition, FIGS. 13A to 13C show various embodiments for an operation of the controller 180 in case that a plurality of objects exist.

According to one embodiment, referring to FIG. 13A, if a plurality of objects are selected by a 1^{st} touch input 310, an active action screen 501 for each of the objects can be simultaneously displayed within an action display region 410. In this case, the action display region 410 may be partitioned as many as the number of the activated actions.

Referring to FIG. 13A (1), if two objects including ‘multi’ and ‘touch’ are selected by a 1^{st} touch input 310 and an action display region 410 is designated by a 2^{nd} touch input 320, a dictionary search for each text 2101 can be separately activated. After the controller has activated actions corresponding to the two objects, respectively, referring to FIG. 13A (2), the controller 180 partitions an action display region 410 into two regions 410b and controls dictionary search results 5012 and 5014 to be displayed on the two regions 410b, respectively.

According to another embodiment, referring to FIG. 13B, if a plurality of objects are selected by a 1^{st} touch input 310, an active action screen 501 for each of the objects can be sequentially displayed on an action display region 410. In this case, each of the active action screens 501 is displayed for prescribed duration and then switched automatically. Alternatively, each of the active action screens 501 may be switched to another active action screen 501 in response to an additional touch input 370 made by a user.

Referring to FIG. 13B (1), if two texts 2101 including ‘multi’ and ‘touch’ are selected by a 1^{st} touch input 310, as mentioned in the description of the above example, a dictionary search for each of the texts 2101 can be separately activated. According to the present embodiment, referring to FIG. 13B (2), the controller 180 performs the dictionary search for each of the texts 2101 and is then able to preferentially display a search result 5012 for the ‘multi’ on an action display region 410. While the search result 5012 for ‘multi’ is displayed, if a user performs an additional touch input 370 via a specific gesture, referring to FIG. 13B (3), a screen within the action display region can be switched to a result screen 5014 of the search for ‘touch’.

According to a further embodiment, referring to FIG. 13C, if a plurality of objects are selected by a 1^{st} touch input 310, the controller 180 may simply display an indication 430 indicating that the 1^{st} touch input 310 needs to be performed again. If two texts ‘multi’ and ‘touch’ 2101 are selected by a 1qst touch input 310 and an action display region 410 is displayed by a 2^{nd} touch input 320 [FIG. 13C (1)], the controller 180 determines the number of objects selected before activating actions for the selected texts 2101. If the number of the selected objects is plural, the controller 180 is able to control a popup window 430, on which an indication ‘select object again’ is displayed, to be displayed on the touchscreen 151.

Effects obtainable from the present invention may be non-limited by the above mentioned effect. And, other unmentioned effects can be clearly understood from the following description by those having ordinary skill in the technical field to which the present invention pertains.

It will be appreciated by those skilled in the art that the present invention can be specified into other form(s) without departing from the spirit or scope of the inventions.

In addition, the above-described methods can be implemented in a program recorded medium as computer-readable codes. The computer-readable media may include all kinds of recording devices in which data readable by a computer system are stored. The computer-readable media may include ROM, RAM, CD-ROM, magnetic tapes, floppy discs, optical data storage devices, and the like for example and also include carrier-wave type implementations (e.g., transmission via Internet). Further, the computer may include the controller 180 of the terminal.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal comprising:
a touchscreen configured to display a screen that includes at least one object;
a memory configured to store information of an action that corresponds to the at least one object; and
a controller to control the touchscreen, wherein in response to selection of one of the at least one object based on a first touch input to the touchscreen and designation of an action display region of the screen based on a second touch input to the touchscreen, the controller to control an active action screen for the selected object to be displayed in the action display region.

2. The mobile terminal of claim 1, wherein the controller detects a prescribed first gesture as the first touch input to the touch screen, and the controller detects a prescribed second gesture as the second touch input to the touch screen, the second gesture being different than the first gesture.

3. The mobile terminal of claim 2, wherein the first gesture includes a tap, and the second gesture includes a touch drag.

4. The mobile terminal of claim 2, wherein the first gesture includes a touch drag to designate a first region, the second gesture includes a touch drag to designate a second region, and wherein a designated region of the second gesture is greater than a designated region of the first gesture.

5. The mobile terminal of claim 1, wherein the controller controls the touchscreen to display the active action screen in response to a third touch input to match a first point, on which the first touch input is performed, to a second point on which the second touch input is performed, and wherein the third touch input is detected after detecting the first touch input and the second touch input.

6. The mobile terminal of claim 1, wherein the action is designated based on a type of the at least one object, wherein the controller determines the type of the selected at least one object, and wherein the type of the at least one object is one of a text, an application icon and a multimedia content.

7. The mobile terminal of claim 6, wherein the type of the selected at least one object is the multimedia content, and wherein the action includes playing the selected at least one object.

8. The mobile terminal of claim 6, wherein the type of the selected at least one object is the text or the multimedia content, and wherein the action includes adding the selected at least one object to a list stored in the memory.

9. The mobile terminal of claim 6, wherein the type of the at least one selected object is the text, and wherein the action includes searching a dictionary stored in the memory for the text or activating a web browser and searching a webpage for the text.

10. The mobile terminal of claim 6, wherein the type of the selected at least one object includes the application icon, and wherein the action includes activating a widget of an application corresponding to the application icon.

11. The mobile terminal of claim 1, wherein the action is designated based on an application activated by the controller.

12. The mobile terminal of claim 11, wherein the screen includes an active screen of the application, and wherein the action designated to the activated application includes searching the application for information on the selected at least one object included in the application and displaying a result of the searching.

13. The mobile terminal of claim 1, wherein when a plurality of actions corresponding to the selected at least one object exist, the controller selects and activates one of the plurality of the actions when another touch input to the touchscreen is detected.

14. The mobile terminal of claim 13, wherein the controller controls a list to be displayed on the touchscreen before displaying the active action screen, and wherein the another touch input is performed to select one of the plurality of the actions provided on the list.

15. The mobile terminal of claim 1, wherein in response to detecting a touch drag input having a start point in the action display region, the controller controls the action display region to be shifted to an end location of the touch drag input based on the end location of the touch drag input or the controller controls the active action screen to be scrolled in the action display region.

16. The mobile terminal of claim 1, wherein while the action is active, the controller controls the designation of the action display region to be cancelled when another touch input is detected in the action display region.

17. The mobile terminal of claim 1, wherein when a plurality of selected objects exist, the controller partitions the action display region into a plurality of sub-regions that correspond to a number of the selected objects, and the controller controls active action screens for the plurality of the selected objects to be simultaneously displayed on the sub-regions, respectively.

18. The mobile terminal of claim 1, wherein when a plurality of selected objects exist, the controller controls the active action screen for each of the plurality of the selected objects to be sequentially displayed within the action display region.

19. A method of controlling a mobile terminal, comprising:
controlling a touchscreen to display a screen that includes at least one object;
detecting a first touch input to select one of the at least one object from the touchscreen;
detecting a second touch input to designate an action display region within the main screen;
activating an action corresponding to the selected object; and
controlling the touchscreen to display an active screen of the action within the action display region.

20. The method of claim 19, wherein the first touch input is a first gesture, and the second touch input is a second gesture that is different from the first gesture.

21. The method of claim 20, wherein the first gesture includes a tap, and the second touch gesture includes a touch drag.

22. The method of claim 20, wherein the first gesture includes a touch drag to designate a first region, the second gesture includes a touch drag to designate a second region, and wherein the designated second region is greater than the designated first region of the first gesture.

23. The method of claim 19, further comprising displaying the active action screen in response to a third touch input that matches a first point, on which the first touch input is performed, to a second point on which the second touch input is performed.

24. The method of claim 19, wherein the action is designated based on a type of the at least one object, and wherein the type of the at least one object includes one of a text, an application icon and a multimedia content.

25. The method of claim 19, wherein the screen includes an active screen of the application, and wherein the action is designated to an activated application includes searching the application for information on the selected at least one object included in the application and displaying a result of the searching.

26. The method of claim 19, wherein when a plurality of actions corresponding to the selected object exist, the method further comprises activating one of the plurality of actions when another touch input to the touchscreen is detected.

27. The method of claim 19, wherein in response to detecting a touch drag input having a start point in the action display region, the action display region is moved to an end location of the touch drag input based on the end location of the touch drag input or the active action screen is scrolled within the action display region.

28. The method of claim 20, wherein the action display region is portioned into sub-regions corresponding to a number of a plurality of selected objects, and the active action screens are controlled for a plurality of the selected objects to be simultaneously displayed on the sub-regions, respectively.

29. The method of claim 19, further comprising sequentially displaying, within the action display region, the active action screen for each of a plurality of selected objects.

30. An electronic recording medium that includes a program recorded therein, the program comprising:
a first code to control a touchscreen to display a screen that includes at least one object;
a second code command to detect a first touch input that selects one of the at least one object from the touchscreen;
a third code to detect a second touch input that designates an action display region of the screen;
a fourth code to activate an action for the selected object; and
a fifth code to control the touchscreen to display an active screen of the action at the action display region.
